(19) United States
(12) Patent Application Publication
(10) Pub. No.: US 2026/0281337 A1
(43) Pub. Date: Sep. 17, 2026

(54) VIDEO CODING AND DECODING METHODS AND APPARATUSES, COMPUTER-READABLE MEDIUM, AND ELECTRONIC DEVICE

(71) Applicant: Tencent Technology (Shenzhen) Company Limited, Shenzhen (CN)

(72) Inventors: Renjie CHANG, Shenzhen (CN); Han ZHU, Shenzhen (CN); Liqiang WANG, Shenzhen (CN); Xiaozhong XU, Shenzhen (CN)

(21) Appl. No.: 19/675,255

(22) Filed: May 12, 2026

Related U.S. Application Data
(63) Continuation of application No. PCT/CN2025/138052, filed on Nov. 27, 2025.

(30) Foreign Application Priority Data
Dec. 4, 2024 (CN) 202411786187.2

(51) Int. Cl. H04N 19/117; H04N 19/119; H04N 19/176; H04N 19/70; H04N 19/82

(52) U.S. Cl. CPC H04N 19/117; H04N 19/119; H04N 19/176; H04N 19/70; H04N 19/82

(57) ABSTRACT

The present application provides a video decoding method performed by an electronic device. The method includes: obtaining a coded video bitstream; decoding the video bitstream to obtain a residual signal of a current block; determining a predicted signal of the current block based on the video bitstream; determining a reconstructed signal of the current block based on the residual signal and the predicted signal; determining statistical information of the residual signal of the current block; comparing the statistical information with a first threshold to obtain a comparison result; and determining whether to perform loop filtering processing on the reconstructed signal based on the comparison result. For each block in each image frame, loop filtering processing is adaptively enabled based on a comparison result between statistical information of a residual signal of the block and a first threshold, thereby effectively reducing decoding complexity, and further improving coding/decoding efficiency.

### CROSS-REFERENCE TO RELATED APPLICATIONS

This application is a continuation application of PCT Patent Application No. PCT/CN2025/138052, entitled “VIDEO CODING AND DECODING METHODS AND APPARATUSES, COMPUTER-READABLE MEDIUM, AND ELECTRONIC DEVICE” filed on Nov. 27, 2025, which claims priority to Chinese Patent Application No. 2024117861872, entitled “VIDEO CODING AND DECODING METHODS AND APPARATUSES, COMPUTER-READABLE MEDIUM, AND ELECTRONIC DEVICE” filed with the China National Intellectual Property Administration on Dec. 4, 2024, all of which are incorporated herein by reference in their entirety.

### FIELD OF THE TECHNOLOGY

This application relates to the field of video coding and decoding, and specifically, to video coding and decoding methods and apparatuses, a computer-readable medium, and an electronic device.

### BACKGROUND OF THE DISCLOSURE

In the field of video coding, a conventional loop filter is usually used to suppress distortion of a reconstructed image, to improve quality of the reconstructed image. However, it is difficult for the conventional loop filter to effectively reduce the distortion of the reconstructed image. A neural network loop filter can bring significant gains to the video coding, but introduces excessively high complexity, severely hindering its application and promotion in actual scenarios. Therefore, a video coding solution that can effectively reduce decoding complexity urgently needs to be proposed.

### SUMMARY

Embodiments of this application provide video coding and decoding methods and apparatuses, a computer-readable medium, an electronic device, and a computer-readable storage medium. In a coding/decoding process, for each block in each image frame, loop filtering processing is adaptively enabled based on a comparison relationship between statistical information corresponding to the block and a first threshold, thereby effectively reducing decoding complexity without significant losses of loop filtering gains, and further improving coding/decoding efficiency.

According to a first aspect, an embodiment of this application provides a video decoding method, including: obtaining a coded video bitstream; decoding the video bitstream to obtain a residual signal of a current block; determining a predicted signal of the current block based on the video bitstream; determining a reconstructed signal of the current block based on the residual signal and the predicted signal; determining statistical information of the residual signal of the current block; comparing the statistical information with a first threshold to obtain a comparison result; and determining whether to perform loop filtering processing on the reconstructed signal based on the comparison result.

According to a second aspect, an embodiment of this application provides a video coding method, including: coding an image frame, to determine a predicted signal and a residual signal of each block in the image frame; reconstructing the coded image frame based on the predicted signal and the residual signal to obtain a reconstructed image; predicting a first threshold of each block in the reconstructed image by performing loop filtering processing on the reconstructed image, the first threshold of each block being configured for comparison with statistical information of a residual signal of each block, to obtain a comparison result, the comparison result being configured for determining whether to perform loop filtering processing on each block on a decoding side; and signaling the first threshold and the residual signal of each block.

According to a third aspect, an embodiment of this application provides a computer-readable medium, having a video bitstream stored therein, the video bitstream being processed by the video decoding method according to the foregoing embodiments.

According to a fourth aspect, an embodiment of this application provides an electronic device, including one or more processors; and a storage apparatus, configured to store one or more computer programs, the one or more computer programs, when executed by the one or more processors, causing the electronic device to implement the video decoding method or the video coding method according to the foregoing embodiments.

### BRIEF DESCRIPTION OF THE DRAWINGS

FIG. 1 is a schematic diagram of an exemplary system architecture to which technical solutions in embodiments of this application may be applied.

FIG. 2 is a schematic diagram of arrangement modes of a video coding apparatus and a video decoding apparatus in a streaming system.

FIG. 3 is a basic flowchart of a video coder.

FIG. 4 shows a manner of using a neural network loop filter.

FIG. 5 is a flowchart of a video decoding method according to an embodiment of this application.

FIG. 6 shows an example of block partitioning on an image.

FIG. 7 is a flowchart of a video coding method according to an embodiment of this application.

FIG. 8 shows an example of image region partition on a reconstructed image.

FIG. 9 is a block diagram of a video decoding apparatus according to an embodiment of this application.

FIG. 10 is a block diagram of a video coding apparatus according to an embodiment of this application.

FIG. 11 is a schematic structural diagram of a computer system adapted to implement an electronic device according to an embodiment of this application.

### DESCRIPTION OF EMBODIMENTS

Exemplary implementations are now described in a more comprehensive manner with reference to the accompanying drawings. However, the exemplary implementations can be implemented in various forms, and are not to be understood as being limited to the examples. On the contrary, the implementations are provided to make this application more thorough and complete, and fully convey the idea of the exemplary implementations to a person skilled in the art.

In addition, the features, structures, or characteristics described in this application may be combined in one or more embodiments in any appropriate manner. The following description has many specific details, so that the embodiments of this application can be fully understood. However, a person skilled in the art is to be aware that, technical solutions of this application may be implemented without using all detailed features in the embodiments, one or more details may be omitted, or other methods, elements, apparatuses, steps, or the like may be used.

In the embodiments of this application, the term “module” or “unit” refers to a computer program with a preset function or a part of the computer program, works together with other related parts to implement a preset target, and may be completely or partially implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

The term “plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” indicates an “or” relationship between the associated objects.

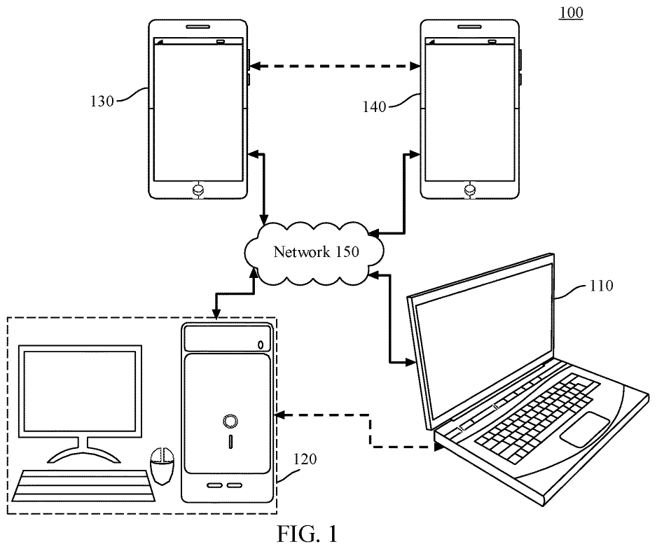

FIG. 1 is a schematic diagram of an exemplary system architecture to which technical solutions in embodiments of this application may be applied.

As shown in FIG. 1, the system architecture 100 includes a plurality of terminal apparatuses, and the terminal apparatuses may communicate with each other through, for example, a network 150. For example, the system architecture 100 may include a first terminal apparatus 110 and a second terminal apparatus 120 that are connected to each other through the network 150. In the embodiment in FIG. 1, the first terminal apparatus 110 and the second terminal apparatus 120 perform unidirectional data transmission.

For example, the first terminal apparatus 110 may code video data (for example, a video picture stream captured by the terminal apparatus 110) for transmission to the second terminal apparatus 120 through the network 150, the coded video data is transmitted in a form of one or more coded video bitstreams, and the second terminal apparatus 120 may receive the coded video data from the network 150, decode the coded video data to restore the video data, and display video pictures based on the restored video data.

In an embodiment of this application, the system architecture 100 may include a third terminal apparatus 130 and a fourth terminal apparatus 140 that perform two-way transmission of coded video data. The two-way transmission may occur, for example, during a video conference. For two-way data transmission, either of the third terminal apparatus 130 and the fourth terminal apparatus 140 may code video data (for example, a video picture stream captured by the terminal apparatus) for transmission to the other one in the third terminal apparatus 130 and the fourth terminal apparatus 140 through the network 150. Either of the third terminal apparatus 130 and the fourth terminal apparatus 140 may receive coded video data transmitted by the other one in the third terminal apparatus 130 and the fourth terminal apparatus 140, may decode the coded video data to restore the video data, and may display video pictures on an accessible display apparatus based on the restored video data.

In the embodiment shown in FIG. 1, the first terminal apparatus 110, the second terminal apparatus 120, the third terminal apparatus 130, and the fourth terminal apparatus 140 may be servers or terminals, but the principles disclosed in this application may not be limited thereto.

The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, an intelligent voice interaction device, a smartwatch, a smart home appliance, an in-vehicle terminal, an aircraft, or the like, but is not limited thereto.

The network 150 shown in FIG. 1 represents any quantity of networks that transmit coded video data between the first terminal apparatus 110, the second terminal apparatus 120, the third terminal apparatus 130, and the fourth terminal apparatus 140, including, for example, wired and/or wireless communication networks. The communication network 150 may exchange data in circuit-switched and/or packet-switched channels. The network may include a telecommunication network, a local area network, a wide area network, and/or the Internet. For this application, unless explained below, an architecture and a topology of the network 150 may be immaterial to operations disclosed in this application.

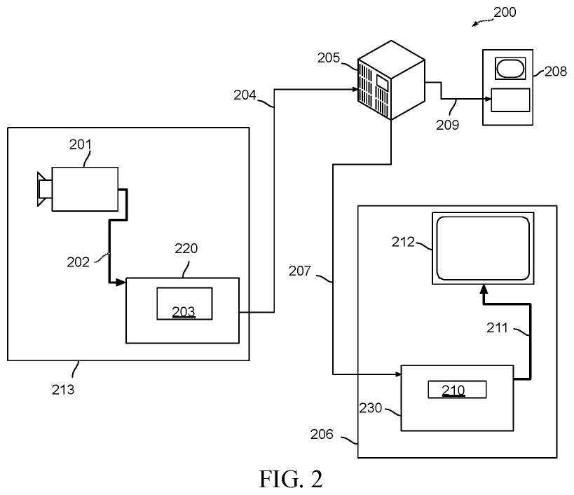

In an embodiment of this application, FIG. 2 shows arrangement modes of a video coding apparatus and a video decoding apparatus in a streaming environment. The subject disclosed in this application may be equally applicable to other video-enabled applications, including, for example, video conferencing, a digital television (TV), and storing of compressed videos on digital media including a compact disc (CD), a digital versatile disc (DVD), a memory stick, and the like.

A streaming system may include a capture subsystem 213. The capture subsystem 213 may include a video source 201 such as a digital camera. The video source creates an uncompressed video picture stream 202. In the embodiment, the video picture stream 202 includes samples that are taken by the digital camera. Compared with coded video data 204 (or a coded video bitstream 204), the video picture stream 202 is depicted as a bold line to emphasize a video picture stream with a high data volume. The video picture stream 202 may be processed by an electronic apparatus 220. The electronic apparatus 220 includes a video coding apparatus 203 coupled to the video source 201. The video coding apparatus 203 may include hardware, software, or a combination of software and hardware, to implement or carry out each aspect of the disclosed subject described below in more details. Compared with the video picture stream 202, the coded video data 204 (or the coded video bitstream 204) is depicted as a thin line to emphasize the coded video data 204 (or the coded video bitstream 204) with a lower data volume, which may be stored on a streaming server 205 for future use. One or more streaming client subsystems, such as a client subsystem 206 and a client subsystem 208 in FIG. 2, may access the streaming server 205 to retrieve a copy 207 and a copy 209 of the coded video data 204. The client subsystem 206 may include, for example, a video decoding apparatus 210 in an electronic apparatus 230. The video decoding apparatus 210 decodes the input copy 207 of the coded video data, and generates a video picture stream 211 that may be displayed on a display 212 (for example, a display screen) or another display apparatus. In some streaming systems, the coded video data 204, video data 207, and video data 209 (for example, video bitstreams) may be coded according to some video coding/compression standards.

The electronic apparatus 220 and the electronic apparatus 230 may include other components not shown in the figure. For example, the electronic apparatus 220 may include a video decoding apparatus, and the electronic apparatus 230 may further include a video coding apparatus.

In an embodiment of this application, by taking international video coding standards such as high efficiency video coding (HEVC) and versatile video coding (VVC) and the Chinese national video coding standard such as an audio video coding standard (AVS) as examples, after a video frame image is inputted, the video frame image is partitioned into several non-overlapping processing units based on a block size, and a similar compression operation is performed on each processing unit. The processing unit is referred to as a coding tree unit (CTU) or a largest coding unit (LCU). The CTU may be further partitioned into one or more basic coding units (CU). The CU is a most basic element in a coding phase.

In another embodiment, the processing unit may also be referred to as a tile, which is a rectangular region of a multimedia data frame that may be independently decoded and coded. In the alliance for open media video 1 (AV1) standard, the tile may be further partitioned into one or more superblocks (SB for short). The SB is a start point of block partitioning and may be further partitioned into a plurality of sub-blocks. Then, the superblock is further partitioned into one or more blocks. Each block is a most basic element in a coding phase. In some embodiments, one SB may include several Bs.

The above partition mode on the video frame image may be referred to as a block partition structure. Some concepts in the coding process are described below:

Predictive coding: The predictive coding includes an intra-frame prediction mode, an inter-frame prediction mode, and the like. A residual video signal (which may be referred to as a residual signal for short) is obtained after prediction of an original video signal through a selected reconstructed video signal. A coding end needs to select a predictive coding mode for a current coding unit (or a coding block) and inform a decoding end. The intra-frame prediction means that a predicted signal is from a region that has been reconstructed through coding and that is in a same image. The inter-frame prediction means that a predicted signal is from another coded image (referred to as a reference image) different from a current image.

Transform and quantization: After a residual video signal undergoes transform operations such as discrete Fourier transform (DFT) and discrete cosine transform (DCT), the signal is transformed into a transform domain, and is referred to as a transform coefficient. A lossy quantization operation is further performed on the transform coefficient, which loses a specific amount of information, so that the quantized signal facilitates compressed expression. In some video coding standards, more than one transform mode may be selected. Therefore, the coding end also needs to select one transform mode for the current coding unit (or the coding block) and inform the decoding end. Quantization fineness is usually determined by a quantization parameter (QP). A larger QP value indicates that coefficients within a larger value range are quantized to a same output. Therefore, larger distortion and a lower bit rate are usually caused. On the contrary, a smaller QP value indicates that coefficients within a smaller value range are quantized to a same output. Therefore, smaller distortion and a corresponding higher bit rate are usually caused.

Entropy coding or statistical coding: Statistical compression coding is performed on a quantized transform-domain signal based on frequencies of occurrence of values, and finally, a binarized (0 or 1) compressed bitstream is outputted. In addition, entropy coding also needs to be performed on other information generated through coding, for example, a selected coding mode and motion vector data, to reduce a bit rate. The statistical coding is a lossless coding mode that can effectively reduce a bit rate desired for expressing a same signal. A common statistical coding mode includes variable length coding (VLC) or context adaptive binary arithmetic coding (CABAC).

A context adaptive binary arithmetic coding (CABAC) process includes three operations: binarization, context modeling, and binary arithmetic coding. After binarization processing is performed on an input syntactic element, binary data may be coded in a regular coding mode and a bypass coding mode. The bypass coding mode does not desire assignment of a specific probability model to each binary bit, and an input binary bit bin value is directly coded by using a simple bypass coder to speed up entire coding and decoding. In general, different syntactic elements are not completely independent, and identical syntactic elements have a particular memory. Therefore, according to a conditional entropy theory, in comparison with independent coding or memoryless coding, using other coded syntactic elements for conditional coding can further improve coding performance. Such coded symbolic information that is used as a condition is referred to as a context. In the regular coding mode, binary bits of a syntactic element sequentially enter a context modeler. The coder assigns a suitable probability model for each inputted binary bit based on a value of a previously coded syntactic element or binary bit. This process is context modeling. A context model corresponding to a syntactic element may be located by using a context index increment (ctxIdxInc) and context index start (ctxIdxStart). After the bin value and the assigned probability model are fed together into a binary arithmetic coder for coding, the context model needs to be updated based on the bin value. This is an adaptive process in the coding.

Loop filtering: Operations such as inverse quantization, inverse transform, and predictive compensation are performed on a transformed and quantized signal to obtain a reconstructed image. The reconstructed image has some information different from that in an original image because of quantization, that is, the reconstructed image may have distortion. Therefore, a filtering operation may be performed on the reconstructed image, for example, by using filters such as a deblocking filter (DB), a sample adaptive offset (SAO) filter, or an adaptive loop filter (ALF), which can effectively reduce a degree of distortion caused by quantization. Since the filtered reconstructed images are to be used as a reference for subsequently coded images to predict future image signals, the filtering operation is also referred to as loop filtering, that is, a filtering operation in a coding loop.

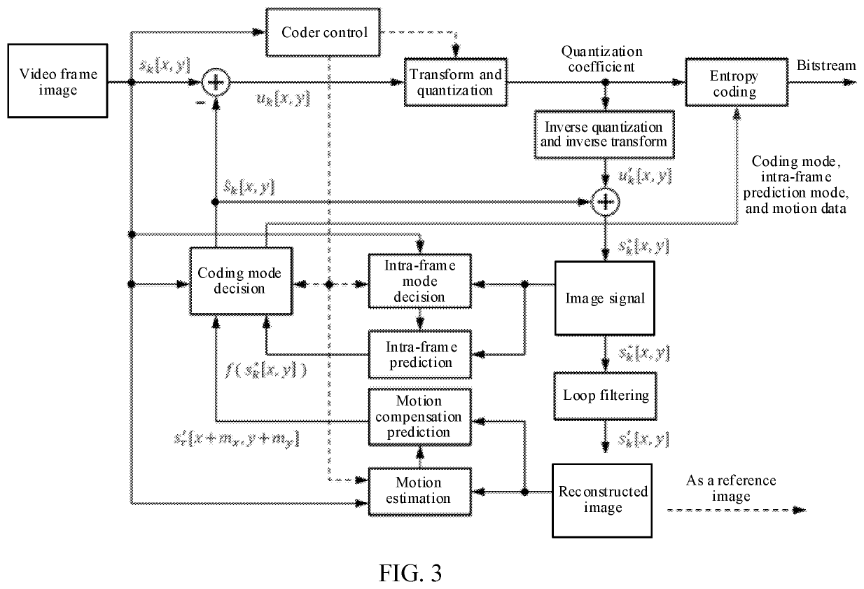

In an embodiment of this application, FIG. 3 is a basic flowchart of a video coder. In this process, intra-frame prediction is used as an example for description. A difference between an original image signal sₖ[x, y] and a predicted image signal ŝₖ[x, y] is calculated to obtain a residual signal uₖ[x, y], and the residual signal uₖ[x, y] is transformed and quantized to obtain a quantization coefficient. The quantization coefficient is subjected to entropy coding to obtain a coded bitstream, and is further subjected to inverse quantization and inverse transform to obtain a reconstructed residual signal u′ₖ[x, y]. The predicted image signal ŝₖ[x, y] is superimposed with the reconstructed residual signal u′ₖ[x, y] to generate an image signal

$${s}_{k}^{*} [ x , y ] .$$

The image signal

$${s}_{k}^{*} [ x , y ]$$

is inputted to an intra-frame mode decision module and an intra-frame prediction unit for intra-frame prediction, and is further subjected to loop filtering to output a reconstructed image signal s′ₖ[x, y]. The reconstructed image signal s′ₖ[x, y] may be used as a reference image for a next frame for motion estimation and motion compensation prediction. Then, a predicted image signal ŝₖ[x, y] of the next frame is obtained based on a motion compensation prediction result s′ᵣ[x+mₓ, y+m_{y}] and an intra-frame prediction result

$$f ( {s}_{k}^{*} [ x , y ] ) .$$

The above process is repeated until the coding is completed.

Based on the above coding process, at the decoding end, for each coding unit (or a coding block), after a compressed bitstream (that is, a bitstream) is obtained, entropy decoding is performed to obtain various mode information and quantization coefficients. Then, inverse quantization and inverse transform are performed on the quantization coefficients to obtain a residual signal. Moreover, a predicted signal corresponding to the coding unit (or the coding block) may be obtained based on the known coding mode information. Then, the residual signal may be added to the predicted signal to obtain a reconstructed signal. The reconstructed signal is subjected to operations such as loop filtering to generate a final output signal.

An existing hybrid coding framework uses a conventional loop filter to suppress distortion of a reconstructed image, to improve quality of the reconstructed image, and expect to restore a coded reconstructed image to an original image. However, the conventional loop filter is based on manual design, it is difficult to effectively reduce the distortion of the reconstructed image, and there is large optimization space. Because of excellent performance of a neural network tool in an image processing aspect, a neural network loop filter (NNLF) is applied to a loop filter module.

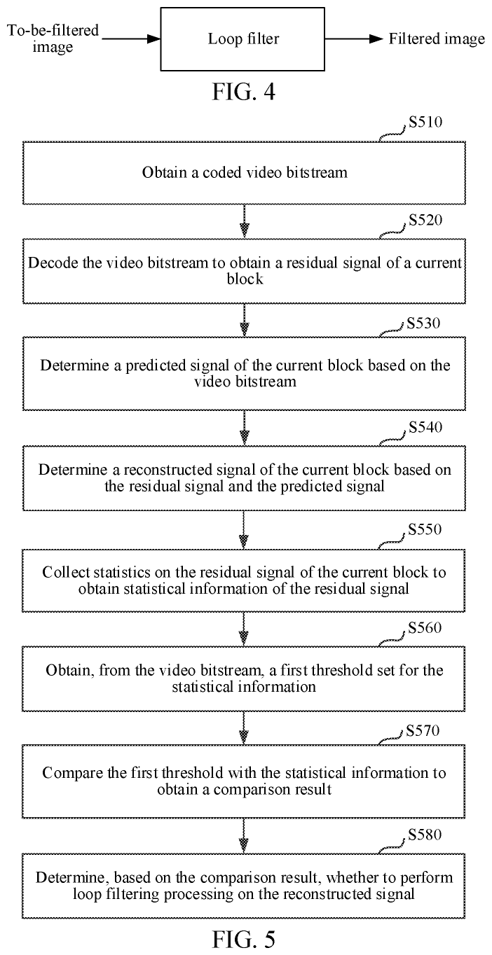

FIG. 4 shows a manner of using a neural network loop filter. A to-be-filtered image is inputted to a trained loop filter, to obtain a filtered image. The neural network loop filter usually uses a loss function to constrain the filtered image, to restore the filtered image to an original image to the greatest extent. The loss function measures a difference between a predicted value and an actual value. A larger loss value indicates a larger difference. A training objective is to reduce the loss value. Common loss functions include, but are not limited to, an L1 norm loss function, an L2 norm loss function, and a Smooth L1 loss function.

The neural network loop filter can bring significant gains to video coding, but introduces excessively high complexity, severely hindering its application and promotion in actual application scenarios. To resolve the problem, the embodiments of this application propose that in a coding/decoding process, for each block in an image frame, loop filtering processing be adaptively enabled based on a magnitude comparison relationship between statistical information of a residual signal of the block and a set first threshold, thereby effectively reducing decoding complexity without significant losses of loop filtering gains.

The following describes the embodiments of this application in detail.

FIG. 5 is a flowchart of a video decoding method according to an embodiment of this application. The video decoding method may be performed by a device with a computational processing function, for example, may be performed by a terminal device or a server. With reference to FIG. 5, the video decoding method includes at least S510 to S580. Detailed descriptions are as follows:
S510: Obtain a coded video bitstream.
S520: Decode the video bitstream to obtain a residual signal of a current block.

At a decoding end, for each block, after the coded video bitstream is obtained, entropy decoding is first performed, to obtain various mode information and quantized transform coefficients. Inverse quantization and inverse transform are performed on each transform coefficient, to correspondingly obtain a residual signal.

The current block mentioned in this embodiment is a block that is being decoded currently.
S530: Determine a predicted signal of the current block based on the video bitstream.
S540: Determine a reconstructed signal of the current block based on the residual signal and the predicted signal.

The decoding end may obtain a predicted signal corresponding to each block based on the known coding mode information. The residual signal may be added to the predicted signal to correspondingly obtain a reconstructed signal.
S550: Determine statistical information of the residual signal of the current block.
S560: Obtain, from the video bitstream, a first threshold set for the statistical information.
S570: Compare the first threshold with the statistical information to obtain a comparison result.

In this embodiment of this application, it is considered that a residual signal during video coding reflects a pixel difference between a predicted image (that is, a predicted signal) and an original image. When residual magnitude is smaller, the difference between the predicted image and the original image is smaller, so that quality of a subsequent reconstructed image is higher, and a loop filtering effect is poorer. When residual magnitude is larger, the difference between the predicted image and the original image is larger, so that quality of a subsequent reconstructed image is lower, and a loop filtering effect is better. Therefore, whether to perform loop filtering processing on each block may be adaptively enabled based on residual information.

The statistical information is used to represent residual magnitude, and the statistical information includes, but is not limited to, a residual pixel statistic and a block partitioning statistic.

The residual pixel statistic aims to represent residual magnitude by using a pixel difference, and the residual pixel statistic is obtained by collecting statistics on a residual pixel of the current block. For example, the residual pixel value statistic may include at least one of the following:

an average pixel value corresponding to the residual signal;
a quantity of non-zero pixel values included in the residual signal;
a ratio of the quantity of non-zero pixel values included in the residual signal to a total quantity of pixels included in the current block;
a quantity of zero pixel values included in the residual signal; and
a ratio of the quantity of zero pixel values included in the residual signal to the total quantity of pixels included in the current block.

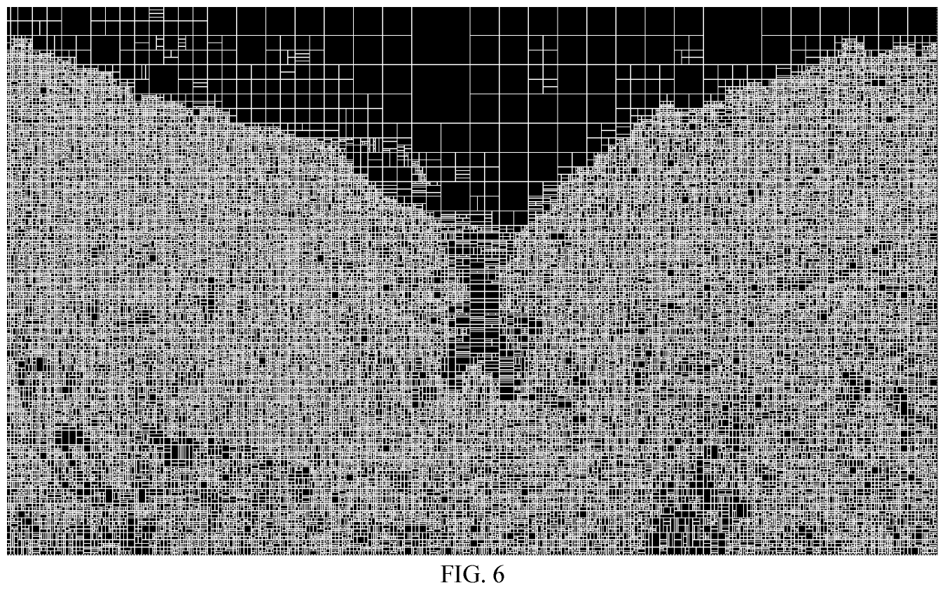

The block partitioning statistic aims to represent residual magnitude by using a block partitioning situation. FIG. 6 shows an example of block partitioning on an image. A white region represents a block partitioning boundary, and a black region represents pixel content on which block partitioning is not performed. It may be learned from FIG. 6 that block partitioning may reflect residual magnitude. To be specific, in a frame, a residual of a region with dense block partitioning is usually larger, and a residual of a region with sparse block partitioning is usually smaller. Therefore, in this embodiment, the residual magnitude is represented by using the block partitioning statistic.

The block partitioning statistic is obtained through decoding. For example, the block partitioning statistic may be determined based on at least one of a quantity of block partitions, depth of block partitioning, and a quantity of times of block partitioning in the current block. For example, there is a preset mapping relationship between the block partitioning statistic and at least one of the quantity of block partitions, the depth of block partitioning, and the quantity of times of block partitioning, and the block partitioning statistic may be calculated based on the preset relationship.

The first threshold is used to represent a boundary of a loop filtering effect. For example, when the statistical information is greater than the first threshold, the loop filtering effect is better, that is, image quality is effectively improved. On the contrary, if the statistical information is less than the first threshold, the loop filtering effect is not significant, that is, image quality is not effectively improved. The first threshold is predicted and transmitted by a coding end. For a prediction process of the first threshold, refer to descriptions in subsequent coding embodiments. Details are not described herein.

After obtaining the statistical information corresponding to the current block through statistics collection, the decoding end compares with the statistical information, the first threshold that is of the current block and that is transmitted from the coding end, to determine, based on the obtained comparison result, whether to perform loop filtering processing on the reconstructed signal corresponding to the current block. Therefore, the decoding end adaptively enables loop filtering processing based on a magnitude comparison relationship between the statistical information corresponding to the current block and the first threshold, thereby effectively reducing decoding complexity without significant losses of loop filtering gains. In short, coding/decoding efficiency can be effectively improved by determining whether to perform loop filtering processing on the reconstructed signal.

In some embodiments of this application, the statistical information of the current block is the residual pixel statistic, and the first threshold is correspondingly a residual magnitude threshold. The decoding end collects statistics on the residual pixel value of the current block to obtain the residual pixel value statistic, and then compares the residual magnitude threshold with the residual pixel value statistic, to determine, based on an obtained comparison result, whether to perform loop filtering processing on the reconstructed signal.

In some embodiments of this application, the statistical information corresponding to the current block is the block partitioning statistic, and the first threshold is correspondingly a block partitioning threshold. After determining the block partitioning statistic corresponding to the current block, the decoding end compares the block partitioning statistic with the block partitioning threshold, to determine, based on an obtained comparison result, whether to perform loop filtering processing on the reconstructed signal.
S580: Determine, based on the comparison result, whether to perform loop filtering processing on the reconstructed signal.

In some embodiments of this application, if the statistical information corresponding to the current block is less than the first threshold corresponding to the current block, it is determined not to perform loop filtering processing on the reconstructed signal corresponding to the current block; otherwise, it is determined to perform loop filtering processing on the reconstructed signal corresponding to the current block.

In some embodiments of this application, if the statistical information corresponding to the current block is greater than the first threshold corresponding to the current block, it is determined not to perform loop filtering processing on the reconstructed signal corresponding to the current block; otherwise, it is determined to perform loop filtering processing on the reconstructed signal corresponding to the current block.

However, regardless of which exemplary embodiment is used to determine whether to perform loop filtering processing on the reconstructed signal corresponding to the current block, a technical principle thereof may be summarized as: performing loop filtering processing on the reconstructed signal corresponding to the current block when the residual is large, to obtain a good loop filtering effect; and not performing loop filtering processing because the loop filtering effect is poor when the residual is small, thereby effectively reducing decoding complexity without significant losses of loop filtering gains.

In some embodiments of this application, the decoding end adaptively enables loop filtering processing based on the comparison result between the statistical information corresponding to the current block and the first threshold. Therefore, in a coding process, coding a loop filtering flag bit block by block to determine whether to enable loop filtering may not be performed, thereby reducing a quantity of bits consumed for coding. The decoding end correspondingly does not obtain, from the compressed video bitstream, a loop filtering flag bit corresponding to the current block.

In some embodiments of this application, the coding end may still code the loop filtering flag bit block by block to determine whether to enable loop filtering. The decoding end obtains, from the compressed video bitstream, the loop filtering flag bit corresponding to the current block, and determines, based on the comparison result and the loop filtering flag bit, whether to perform loop filtering processing on the reconstructed signal corresponding to the current block.

In some embodiments of this application, a manner of determining, based on the comparison result and the loop filtering flag bit, whether to perform loop filtering processing on the reconstructed signal corresponding to the current block may include at least one of the following:
determining a corresponding loop filtering flag value based on the comparison result, and overwriting the loop filtering flag bit based on the loop filtering flag value, to determine, based on an overwritten loop filtering flag bit, whether to perform loop filtering processing on the reconstructed signal; and
removing the loop filtering flag bit, and determining, based on the comparison result, whether to perform loop filtering processing on the reconstructed signal. In some embodiments, if the comparison result indicates that filtering is needed, the loop filtering flag value is set to 1 (enabling loop filtering). If the comparison result indicates that filtering is not needed, the loop filtering flag value is set to 0 (disabling loop filtering).

In some embodiments of this application, a manner of determining, based on the comparison result and the loop filtering flag bit, whether to perform loop filtering processing on the reconstructed signal corresponding to the current block may include at least one of the following:
overwriting the comparison result based on the loop filtering flag bit, to determine, based on an overwritten comparison result, whether to perform loop filtering processing on the reconstructed signal; and
removing the comparison result, and determining, based on the loop filtering flag bit, whether to perform loop filtering processing on the reconstructed signal.

The loop filtering processing mentioned in this embodiment may be implemented by invoking conventional loop filters such as a deblocking filter (DBF), an adaptive loop filter (ALF), and a sample adaptive offset (SAO) filter, or may be implemented by invoking a neural network filter.

The video decoding method mentioned in this embodiment may be applied to at least one of a frame level, a block level, a coding tree unit (CTU) level, a prediction unit (PU) level, and a transform unit (TU) level, or may be applied to at least one of a Y component, a U component, and a V component.

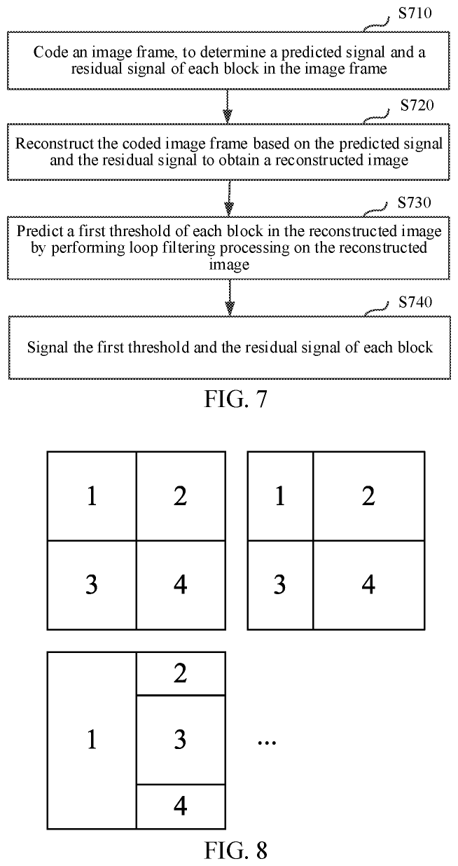

FIG. 7 is a flowchart of a video coding method according to an embodiment of this application. The video coding method may be performed by a device with a computational processing function, for example, may be performed by a terminal device or a server. With reference to FIG. 7, the video coding method includes at least S710 to S740. Detailed descriptions are as follows:
S710: Code an image frame, to determine a predicted signal and a residual signal of each block in the image frame.
S720: Reconstruct the coded image frame based on the predicted signal and the residual signal to obtain a reconstructed image.

In a coding process, inverse quantization and inverse transform operations may be performed on the residual signal of the coded image frame, to obtain a reconstructed residual signal. A sum of the reconstructed residual signal and the predicted signal is the reconstructed image. The reconstructed image has some information different from that in an original image because of quantization, that is, distortion exists. Therefore, loop filtering processing needs to be performed on the reconstructed image.
S730: Predict a first threshold of each block in the reconstructed image by performing loop filtering processing on the reconstructed image, the first threshold of each block being configured for comparison with statistical information of a residual signal of each block, to obtain a comparison result, the comparison result being configured for determining whether to perform loop filtering processing on each block on a decoding side.

The comparison result between the statistical information corresponding to each block in the reconstructed image and the first threshold is used to determine whether to perform loop filtering processing on each block. Therefore, performing loop filtering processing on the reconstructed image based on different first thresholds causes different filtering effects correspondingly.

This may also be understood as that, a quantity of blocks on which loop filtering processing has been performed in a filtered image is controlled by the first threshold, so that quantities of blocks on which loop filtering processing has been performed in filtered images obtained by performing loop filtering processing on the reconstructed image based on different first thresholds are correspondingly different.

The first threshold that corresponds to each block in the reconstructed image and that is predicted by a coding end by performing loop filtering processing on the reconstructed image may be a first threshold causing the reconstructed image to obtain an optimal filtering effect, or may be a first threshold causing a filtering effect obtained for the reconstructed image to reach a preset filtering effect.

In some embodiments of this application, a process in which the coding end predicts the first threshold corresponding to each block in the reconstructed image by performing loop filtering processing on the reconstructed image includes the following operations:
S731: Traverse a preset first threshold candidate list, and determine, based on a traversed first threshold, a quantity of blocks filtered for the reconstructed image.
S732: Perform loop filtering processing on the reconstructed image based on the quantity of blocks, to obtain filtering distortion.
S733: Calculate a corresponding filtering cost based on the filtering distortion and the quantity of blocks.
S734: Select a first threshold from the first threshold candidate list based on a filtering cost corresponding to each first threshold in the first threshold candidate list.
S735: Determine the first threshold of each block in the reconstructed image based on the selected first threshold.

In the foregoing process, the first threshold candidate list includes at least one preset first threshold. The at least one first threshold included in the first threshold candidate list may be predetermined through filtering performance on a video coding/decoding quantity on which statistics collection is performed in advance.

For each first threshold traversed from the first threshold candidate list, a process of determining, based on the first threshold, a quantity of blocks filtered for the reconstructed image, then performing loop filtering processing on the reconstructed image based on the quantity of blocks, to obtain filtering distortion, and calculating a corresponding filtering cost based on the filtering distortion and the quantity of blocks is performed, to predict the filtering cost of performing loop filtering processing on the reconstructed image by using the first threshold. The filtering cost may be understood as a measuring value of a filtering effect. A lower filtering cost indicates a better filtering effect, and a higher filtering cost indicates a poorer filtering effect.

Determining, based on the first threshold, the quantity of blocks filtered for the reconstructed image means determining, based on the comparison result between the statistical information corresponding to each block and the first threshold, whether to perform loop filtering processing on each block, to obtain the quantity of blocks filtered for the reconstructed image. For example, if the statistical information is less than the first threshold, it is determined not to perform loop filtering processing; otherwise, it is determined to perform loop filtering processing. Alternatively, if the statistical information is greater than the first threshold, it is determined not to perform loop filtering processing; otherwise, it is determined to perform loop filtering processing.

For example, it is assumed that a reconstructed image includes 10 blocks, statistical information of the blocks is respectively 1, 2, 3, . . . , and 10, and first thresholds included in the first threshold candidate list are respectively 2, 5, 8, and 11. In this case, when the first threshold is 2, statistical information of one block in the reconstructed image is less than 2. If it is determined not to perform loop filtering processing when the statistical information is less than the first threshold, a quantity of blocks filtered for the reconstructed image is 9. Similarly, when the first threshold is 8, statistical information of seven blocks in the reconstructed image is less than 8, and a quantity of blocks filtered for the reconstructed image is 3.

The filtering distortion means a pixel difference between the original image corresponding to the reconstructed image and the filtered image corresponding to the reconstructed image. For example, a mean absolute error (MAE) of pixels between the original image and the filtered image may be calculated, to obtain the filtering distortion. Alternatively, a mean squared error (MSE) of the pixels between the original image and the filtered image may be calculated, to obtain the filtering distortion.

In some embodiments of this application, the filtering cost may be obtained by calculating a sum of the filtering distortion and the quantity of blocks filtered for the reconstructed image.

In some embodiments of this application, a filtering factor may be determined based on an image feature corresponding to the coded image frame, then a product of the filtering factor and the quantity of blocks filtered for the reconstructed image may be calculated, and a sum of the product and the filtering distortion may be calculated, to obtain the filtering cost. The image feature includes, but is not limited to, at least one of a quantization parameter (QP), a block size, and an image resolution. It may also be understood that the filtering factor may be derived from information such as the quantization parameter, the block size, and the image resolution.

The calculation process may be expressed as the following formula:

$$Cost = D + λ * n$$

Cost represents the filtering cost, D represents the filtering distortion, A represents the filtering factor, and N represents the quantity of blocks filtered for the reconstructed image. In this way, a corresponding filtering cost for each first threshold in the first threshold candidate list is calculated.

In some embodiments of this application, a first threshold having a smallest filtering cost may be selected as the selected first threshold, or another first threshold may be selected from the first threshold candidate list as the selected first threshold based on a filtering cost.

In some embodiments of this application, the selected first threshold may be used as the first threshold corresponding to each block in the reconstructed image, or a preset operation may be performed based on the selected first threshold, to obtain the first threshold corresponding to each block in the reconstructed image.

In some embodiments of this application, a process in which the coding end predicts the first threshold corresponding to each block in the reconstructed image by performing loop filtering processing on the reconstructed image includes the following operations:
S736: Determine, based on an initial first threshold, a quantity of blocks filtered for the reconstructed image, and perform loop filtering processing on the reconstructed image based on the quantity of blocks, to obtain filtering distortion.
S737: Calculate a corresponding filtering cost based on the filtering distortion and the quantity of blocks.
S738: Iteratively perform a process of updating the first threshold according to a preset rule, performing loop filtering processing on the reconstructed image based on an updated first threshold, and obtaining a corresponding filtering cost, until the updated first threshold exceeds a preset value range.
S739: Select a first threshold from first thresholds based on filtering costs corresponding to the first thresholds, and determine, based on the selected first threshold, the first threshold corresponding to each block in the reconstructed image.

In the foregoing process, an initial first threshold is preset, and a filtering cost corresponding to application of the initial first threshold to loop filtering processing of the reconstructed image is obtained. The initial first threshold may alternatively be predetermined through filtering performance on a video coding/decoding quantity on which statistics collection is performed in advance. Then, a process of updating the first threshold according to the preset rule and obtaining a filtering cost corresponding to application of an updated first threshold to loop filtering processing of the reconstructed image is iteratively performed until the updated first threshold exceeds the preset value range. The preset rule may be ascending or descending based on a preset value, or may be another rule. This is not limited herein. Finally, a target first threshold is selected from the first thresholds based on the filtering costs corresponding to the first thresholds, and the first threshold corresponding to each block in the reconstructed image is determined based on the target first threshold.

For determining the quantity of blocks filtered for the reconstructed image, obtaining the filtering distortion, calculating the filtering cost, a manner of selecting the target first threshold, and a manner of finally determining the first threshold based on the target first threshold in this embodiment, refer to related descriptions in the foregoing embodiments. Details are not described herein again.
S740: Signal the first threshold and the residual signal of each block to a decoding end.

After obtaining, through prediction, the first threshold corresponding to each block included in the reconstructed image, the coding end transmits the first threshold and the residual signal that correspond to each block to a decoding end, so that the decoding end performs decoding processing corresponding to each block based on the first threshold and the residual signal that correspond to each block. For a process in which the decoding end performs decoding processing on each block based on the first threshold transmitted by the coding end, refer to the embodiment shown in FIG. 5. Details are not described herein again.

The coding end may not need to transmit a block-level loop filtering flag bit to the decoding end to represent switching of a loop filter corresponding to each block, thereby reducing a quantity of bits for coding. Certainly, in some embodiments of this application, the coding end may still transmit a block-level loop filtering flag bit to the decoding end. For an operation on the loop filtering flag bit when the decoding end decodes each block, refer to descriptions in the foregoing embodiments.

The video coding method mentioned in this embodiment may be applied to at least one of a frame level, a block level, a coding tree unit (CTU) level, a prediction unit (PU) level, and a transform unit (TU) level, or may be applied to at least one of a Y component, a U component, and a V component.

The loop filtering processing mentioned in this embodiment may be implemented by invoking conventional loop filters such as a deblocking filter (DBF), an adaptive loop filter (ALF), and a sample adaptive offset (SAO) filter, or may be implemented by invoking a neural network filter.

The statistical information mentioned in this embodiment includes, but is not limited to, a residual pixel statistic and a block partitioning statistic. When the statistical information is the residual pixel value statistic, the first threshold is a residual magnitude threshold. When the statistical information is the block partitioning statistic, the first threshold is a block partitioning threshold, that is, a threshold for the block partitioning statistic.

The block partitioning statistic may be determined based on at least one of a quantity of block partitions, depth of block partitioning, and a quantity of times of block partitioning in a current block. For example, the block partitioning statistic is the same as one of the quantity of block partitions, the depth of block partitioning, and the quantity of times of block partitioning in the current block. For another example, there is a mapping relationship between the block partitioning statistic and at least two of the quantity of block partitions, the depth of block partitioning, and the quantity of times of block partitioning in the current block. That is, the block partitioning statistic may be determined based on the mapping relationship and the at least two of the quantity, the depth, and the quantity of times.

The residual pixel value statistic may include at least one of the following:
an average pixel value corresponding to the residual signal;
a quantity of non-zero pixel values included in the residual signal;
a ratio of the quantity of non-zero pixel values included in the residual signal to a total quantity of pixels included in the current block;
a quantity of zero pixel values included in the residual signal; and
a ratio of the quantity of zero pixel values included in the residual signal to the total quantity of pixels included in the current block.

In some embodiments of this application, when the reconstructed image includes at least two image regions, a first threshold corresponding to each image region is predicted, and the first threshold corresponding to each block included in the reconstructed image is determined based on the first threshold corresponding to each image region.

A specific partition manner of the image regions is not limited in this embodiment, and region sizes of the image regions may be the same or may be different. For example, FIG. 8 shows an example of image region partition on a reconstructed image. The reconstructed image is partitioned into four image regions in a plurality of partition manners.

A process of predicting the first threshold corresponding to each image region in this embodiment is like the process of predicting the first threshold in S730. Details are not described herein again.

After the first threshold corresponding to each image region is obtained, the first threshold corresponding to each image region may be used as a first threshold corresponding to each block included in the image region. For example, it is assumed that a first threshold corresponding to an image region 1 is r₁, a first threshold corresponding to an image region 2 is r₂, a first threshold corresponding to an image region 3 is r₃, and a first threshold corresponding to an image region 4 is r₄. In this case, first thresholds corresponding to blocks included in the image region 1 are all r₁, first thresholds corresponding to blocks included in the image region 2 are all r₂, first thresholds corresponding to blocks included in the image region 3 are all r₃, and first thresholds corresponding to blocks included in the image region 4 are all r₄.

After the first threshold corresponding to each image region is obtained, a frame-level first threshold may be determined based on the first threshold corresponding to each image region, and the frame-level first threshold is used as the first threshold corresponding to each block included in the reconstructed image. For example, a sum of first thresholds corresponding to all image regions may be used as the frame-level first threshold, or a weighted sum operation or an operation in another manner may be performed on the first thresholds corresponding to all the image regions, to obtain the frame-level first threshold.

A processing process of the coding end is like a processing process of the decoding end. For details, refer to the foregoing processing process of the decoding end. Details are not described in this embodiment again.

The following describes apparatus embodiments of this application, which may be used to perform the methods in the foregoing embodiments of this application. For details not disclosed in the apparatus embodiments of this application, refer to the foregoing method embodiments of this application.

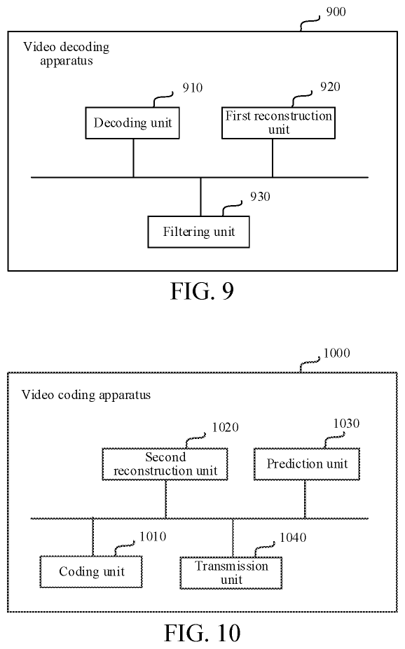

FIG. 9 is a block diagram of a video decoding apparatus according to an embodiment of this application. The video decoding apparatus may be disposed in a device with a computational processing function, for example, may be disposed in a terminal device or a server.

Refer to FIG. 9. The video decoding apparatus 900 according to the embodiment of this application includes a decoding unit 910, a first reconstruction unit 920, and a filtering unit 930.

The decoding unit 910 is configured to: obtain a coded video bitstream; decode the video bitstream to obtain a residual signal of a current block; and determine a predicted signal of the current block based on the video bitstream.

The first reconstruction unit 920 is configured to determine a reconstructed signal of the current block based on the residual signal and the predicted signal.

The filtering unit 930 is configured to: Determine statistical information of the residual signal of the current block; obtain, from the video bitstream, a first threshold set for the statistical information; compare the first threshold with the statistical information to obtain a comparison result; and determine, based on the comparison result, whether to perform loop filtering processing on the reconstructed signal.

In some embodiments of this application, based on the foregoing solution, the statistical information includes a residual pixel value statistic, and the first threshold includes a residual magnitude threshold. The filtering unit 930 is further configured to perform the following operations:
collecting statistics on a residual pixel value of the current block to obtain the residual pixel value statistic; and
comparing the residual magnitude threshold with the residual pixel value statistic.

In some embodiments of this application, based on the foregoing solution, the residual pixel value statistic includes at least one of the following:
an average pixel value corresponding to the residual signal;
a quantity of non-zero pixel values included in the residual signal;
a ratio of the quantity of non-zero pixel values to a total quantity of pixels included in the current block;
a quantity of zero pixel values included in the residual signal; and
a ratio of the quantity of zero pixel values to the total quantity of pixels included in the current block.

In some embodiments of this application, based on the foregoing solution, the statistical information includes a block partitioning statistic, and the first threshold includes a block partitioning threshold. The filtering unit 930 is further configured to perform the following operations:
determining the block partitioning statistic corresponding to the current block; and
comparing the block partitioning threshold with the block partitioning statistic.

In some embodiments of this application, based on the foregoing solution, the block partitioning statistic is determined based on at least one of a quantity of block partitions, depth of block partitioning, and a quantity of times of block partitioning in the current block.

In some embodiments of this application, based on the foregoing solution, the filtering unit 930 is further configured to perform the following operations:
determining not to perform loop filtering processing on the reconstructed signal if the statistical information is less than the first threshold; otherwise, determining to perform loop filtering processing on the reconstructed signal; or
determining not to perform loop filtering processing on the reconstructed signal if the statistical information is greater than the first threshold; otherwise, determining to perform loop filtering processing on the reconstructed signal.

In some embodiments of this application, based on the foregoing solution, the filtering unit 930 is further configured to perform the following operations:
obtaining a loop filtering flag bit corresponding to the current block from the video bitstream, the loop filtering flag bit being configured for indicating whether to enable loop filtering on the current block; and
determining, based on the comparison result and the loop filtering flag bit, whether to perform loop filtering processing on the reconstructed signal.

In some embodiments of this application, based on the foregoing solution, a manner of determining, based on the comparison result and the loop filtering flag bit, whether to perform loop filtering processing on the reconstructed signal includes at least one of the following:
determining a corresponding loop filtering flag value based on the comparison result, and overwriting the loop filtering flag bit based on the loop filtering flag value, to determine, based on an overwritten loop filtering flag bit, whether to perform loop filtering processing on the reconstructed signal;
removing the loop filtering flag bit, and determining, based on the comparison result, whether to perform loop filtering processing on the reconstructed signal;
overwriting the comparison result based on the loop filtering flag bit, to determine, based on an overwritten comparison result, whether to perform loop filtering processing on the reconstructed signal; and
removing the comparison result, and determining, based on the loop filtering flag bit, whether to perform loop filtering processing on the reconstructed signal.

In some embodiments of this application, based on the foregoing solution, the loop filtering processing is performed by invoking a neural network model. In some embodiments, the neural network model may be a known neural network model used for loop filtering processing. In some embodiments, the neural network model is, for example, a convolutional neural network (CNN). An input of the neural network model is the reconstructed signal of the current block. This is usually a two-dimensional pixel block (for example, a 64×64 CU). In a color video, Y, U, and V components may be separately processed, or the three may be used as different input channels. In addition, the input may further include the quantization parameter (QP) of the current block mentioned above. An output of the neural network model is a filtered reconstructed signal, and a size is completely the same as that of the inputted block. An objective of the model is to map the input to a higher-quality version that is closer to an original uncompressed image. For example, the convolutional neural network model may include a first convolutional layer and at least one deep feature extraction layer. The first convolutional layer is used to use a convolutional kernel (a size is, for example, 5×5 or 3×3) for rapidly extracting a shallow feature (for example, an edge or a texture) from a reconstructed image. Each deep feature extraction layer is a depthwise separable convolutional layer, and is used to perform spatial filtering on each input channel to capture a spatial feature, and combine depthwise convolution output channels by using 1×1 convolution, to be responsible for capturing an inter-channel feature. The spatial feature represents a relationship between pixels in two-dimensional space (height and width dimensions). The inter-channel feature is information that spans multiple channels, and focuses on how information represented by different channels is interacted, combined, and weighted at a same spatial position. It determines how to “mix” information of channels to form a more complex representation. A model training manner includes: obtaining a reconstructed image-original image pairing data block group, where each data block group includes a reconstructed image block and a corresponding original image block; and minimizing a difference between a filtered image output by the model and an original image, to obtain a trained model.

In some embodiments of this application, based on the foregoing solution, the video decoding apparatus 900 may be used in at least one of a frame level, a block level, a coding tree unit level, a prediction unit level, and a transform unit level, or used in at least one of a Y component, a U component, and a V component.

The video decoding apparatus provided in the foregoing embodiment and the video decoding method provided in the foregoing embodiment belong to the same idea. Specific manners in which the modules and units perform operations have been described in detail in the method embodiments. Details are not described herein again. In actual application, the video decoding apparatus provided in the foregoing embodiment may allocate, according to requirements, the foregoing functions to different function modules for completion. To be specific, an internal structure of the apparatus is divided into different function modules to complete all or some of the functions described above. This is not limited herein.

FIG. 10 is a block diagram of a video coding apparatus according to an embodiment of this application. The video coding apparatus may be disposed in a device with a computational processing function, for example, may be disposed in a terminal device or a server.

Refer to FIG. 10. The video coding apparatus 1000 according to the embodiment of this application includes a coding unit 1010, a second reconstruction unit 1020, a prediction unit 1030, and a transmission unit 1040.

The coding unit 1010 is configured to code an image frame, to determine a predicted signal and a residual signal of each block in the image frame.

The second reconstruction unit 1020 is configured to reconstruct the coded image frame based on the predicted signal and the residual signal to obtain a reconstructed image.

The prediction unit 1030 is configured to predict a first threshold of each block in the reconstructed image by performing loop filtering processing on the reconstructed image, the first threshold of each block being configured for comparison with statistical information of a residual signal of each block, to obtain a comparison result, the comparison result being configured for determining whether to perform loop filtering processing on each block on a decoding side.

The transmission unit 1040 is configured to signal the first threshold and the residual signal of each block. In some embodiments of this application, based on the foregoing solution, the prediction unit 1030 is further configured to perform the following operations:
traversing a preset first threshold candidate list, and determining, based on a traversed first threshold, a quantity of blocks filtered for the reconstructed image;
performing loop filtering processing on the reconstructed image based on the quantity of blocks, to obtain filtering distortion;
calculating a corresponding filtering cost based on the filtering distortion and the quantity of blocks;
selecting a first threshold from the first threshold candidate list based on a filtering cost corresponding to each first threshold in the first threshold candidate list; and
determining the first threshold of each block in the reconstructed image based on the selected first threshold.

In some embodiments of this application, based on the foregoing solution, the prediction unit 1030 is further configured to perform the following operations:
determining, based on an initial first threshold, a quantity of blocks filtered for the reconstructed image;
performing loop filtering processing on the reconstructed image based on the quantity of blocks, to obtain filtering distortion;
calculating a corresponding filtering cost based on the filtering distortion and the quantity of blocks;
iteratively performing a process of updating the first threshold according to a preset rule, performing loop filtering processing on the reconstructed image based on an updated first threshold, and obtaining a corresponding filtering cost, until the updated first threshold exceeds a preset value range; and
selecting a first threshold from first thresholds based on filtering costs corresponding to the first thresholds, and determining, based on the selected first threshold, the first threshold corresponding to each block in the reconstructed image.

In some embodiments of this application, based on the foregoing solution, a process in which the prediction unit 1030 calculates the corresponding filtering cost based on the filtering distortion and the quantity of blocks includes:
determining a filtering factor based on an image feature of the coded image frame, the image feature including at least one of a quantization parameter, a block size, and an image resolution; and
calculating a product of the filtering factor and the quantity of blocks, and calculating a sum of the filtering distortion and the product, to obtain the filtering cost corresponding to the traversed first threshold.

In some embodiments of this application, based on the foregoing solution, the prediction unit 1030 is further configured to perform the following operations:
predicting a first threshold of each image region when the reconstructed image includes at least two image regions; and
determining the first threshold of each block based on the first threshold of each image region.

In some embodiments of this application, based on the foregoing solution, the prediction unit 1030 is further configured to perform the following operations:
using the first threshold of each image region as a first threshold of each block included in the image region;
or
determining a frame-level first threshold based on the first threshold of each image region, and using the frame-level first threshold as the first threshold of each block.

In some embodiments of this application, based on the foregoing solution, the statistical information includes a residual pixel value statistic, and the first threshold includes a residual magnitude threshold; or

the statistical information includes a block partitioning statistic, and the first threshold includes a block partitioning threshold.

In some embodiments of this application, based on the foregoing solution, the video coding apparatus 1000 may be used in at least one of a frame level, a block level, a coding tree unit level, a prediction unit level, and a transform unit level, or used in at least one of a Y component, a U component, and a V component.

The video coding apparatus provided in the foregoing embodiment and the video coding method provided in the foregoing embodiment belong to the same idea. Specific manners in which the modules and units perform operations have been described in detail in the method embodiments. Details are not described herein again. In actual application, the video coding apparatus provided in the foregoing embodiment may allocate, according to requirements, the foregoing functions to different function modules for completion. To be specific, an internal structure of the apparatus is divided into different function modules to complete all or some of the functions described above. This is not limited herein.

This application further separately provides a method and an apparatus for processing a video bitstream. The video bitstream may be generated according to the video coding method provided in the foregoing embodiments, or the video bitstream is decoded according to the video decoding method provided in the foregoing embodiments.

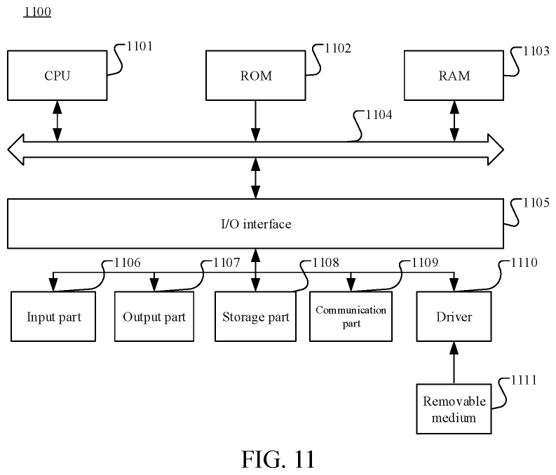

FIG. 11 is a schematic structural diagram of a computer system adapted to implement an electronic device according to an embodiment of this application. The electronic device may be the video coding apparatus or the video decoding apparatus in the foregoing embodiments.

The computer system 1100 of the electronic device shown in FIG. 11 is merely an example, and does not constitute any limitation on functions and use ranges of the embodiments of this application.

As shown in FIG. 11, the computer system 1100 may include a central processing unit (CPU) 1101, which may perform various suitable actions and processing based on a program stored in a read-only memory (ROM) 1102 or a program loaded from a storage part 1108 into a random access memory (RAM) 1103, for example, perform the method described in the foregoing embodiments. The RAM 1103 further stores various programs and data required for system operations. The CPU 1101, the ROM 1102, and the RAM 1103 are connected to each other through a bus 1104. An input/output (I/O) interface 1105 is also connected to the bus 1104.

The following components may be connected to the I/O interface 1105: an input part 1106 including a keyboard, a mouse, and the like, an output part 1107 including a cathode ray tube (CRT), a liquid crystal display (LCD), a speaker, and the like, a storage part 1108 including a hard disk and the like, and a communication part 1109 including network interface cards such as a local area network (LAN) card and a modem. The communication part 1109 performs communication processing through a network such as the Internet. A driver 1110 is also connected to the I/O interface 1105 as required. A removable medium 1111, such as a magnetic disk, an optical disk, a magneto-optical disk, or a semiconductor memory, is mounted on the driver 1110 as required, so that a computer program read therefrom is installed into the storage part 1108 as required.

Particularly, according to the embodiments of this application, the processes described above by referring to the flowcharts may be implemented as computer software programs. For example, an embodiment of this application includes a computer program product. The computer program product includes a computer program carried on a computer-readable medium, and the computer program is used to perform the methods shown in the flowcharts. In such an embodiment, the computer program may be downloaded from a network through the communication part 1109 and installed, and/or installed from the removable medium 1111. When the computer program is executed by the central processing unit (CPU) 1101, the various functions defined in the system of this application are executed.

The computer-readable medium shown in the embodiments of this application may be a computer-readable signal medium or a computer-readable storage medium or any combination of the two. The computer-readable storage medium may be, for example, but is not limited to, an electric, magnetic, optical, electromagnetic, infrared, or semi-conductive system, apparatus, or device, or any combination of the above. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any appropriate combination thereof. In this application, the computer-readable storage medium may be any tangible medium including or storing a computer program, and the computer program may be used by or used in combination with an instruction execution system, apparatus, or device. In this application, the computer-readable signal medium may include a data signal transmitted in a baseband or as part of a carrier, and stores a computer-readable computer program. A data signal propagated in such a way may be in a plurality of forms, including, but not limited to, an electromagnetic signal, an optical signal, or any appropriate combination thereof. The computer-readable signal medium may alternatively be any computer-readable medium other than the computer-readable storage medium. The computer-readable medium may send, propagate, or transmit a program that is used by or used in combination with an instruction execution system, apparatus, or device. The computer program included in the computer-readable medium may be transmitted by using any suitable medium, including but not limited to: wireless, wired, or the like, or any suitable combination thereof.

The flowcharts and block diagrams in the accompanying drawings illustrate system architectures, functions, and operations that may be implemented by the system, the method, and the computer program product according to various embodiments of this application. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may alternatively occur in a sequence different from that annotated in the accompanying drawings. For example two boxes shown in succession may be performed in parallel, and sometimes the two boxes may be performed in a reverse sequence. This is determined by a related function. Each box in a block diagram or a flowchart and a combination of boxes in the block diagram or the flowchart may be implemented by using a dedicated hardware-based system configured to perform a specified function or operation, or may be implemented by using a combination of dedicated hardware and a computer program.

A related unit described in the embodiments of this application may be implemented in a software manner, or may be implemented in a hardware manner, and the described unit may alternatively be disposed in a processor. Names of the units do not constitute a limitation on the units in a specific case.

According to another aspect, this application further provides a computer-readable medium. The computer-readable medium may be included in the electronic device described in the foregoing embodiments, or may exist alone and is not disposed in the electronic device. The foregoing computer-readable medium carries one or more computer programs. The one or more computer programs, when executed by the electronic device, cause the electronic device to implement the methods described in the foregoing embodiments.

Although a plurality of modules or units of a device configured to perform actions are discussed in the foregoing detailed descriptions, such division is not mandatory. According to the implementations of this application, features and functions of two or more modules or units described above may be specifically implemented in one module or unit. On the contrary, a feature and a function of one module or unit described above may be further divided to be specifically implemented by a plurality of modules or units.

Based on the foregoing descriptions of the implementations, a person skilled in the art readily understands that the exemplary implementations described herein may be implemented by using software, or may be implemented by combining software and necessary hardware. Therefore, the technical solutions according to the implementations of this application may be implemented in a form of a software product. The software product may be stored in a non-volatile storage medium (which may be a CD-ROM, a USB flash drive, a removable hard disk, or the like) or on a network, including several instructions to cause an electronic device to perform the method according to the implementations of this application.

For example, the electronic device may be a video decoding apparatus, and the video decoding apparatus may perform the video decoding method shown in FIG. 5. For another example, the electronic device may be a video coding apparatus, and the video coding apparatus may perform the video coding method shown in FIG. 7.

After considering the specification and practicing the implementations of the present disclosure, a person skilled in the art easily conceives of other implementations of this application. This application is intended to cover any variation, use, or adaptive change of this application. These variations, uses, or adaptive changes follow the general principles of this application and include common general knowledge or common technical means in the art, which are not disclosed in this application.

This application is not limited to the precise structures described above and shown in the accompanying drawings, and various modifications and changes can be made without departing from the scope of this application. The scope of this application is subject only to the appended claims.

What is claimed is:

1. A video decoding method, the method comprising:
obtaining a coded video bitstream;
decoding the video bitstream to obtain a residual signal of a current block;
determining a predicted signal of the current block based on the video bitstream;
determining a reconstructed signal of the current block based on the residual signal and the predicted signal;
determining statistical information of the residual signal of the current block;
comparing the statistical information with a first threshold to obtain a comparison result; and
determining whether to perform loop filtering processing on the reconstructed signal based on the comparison result.

2. The method according to claim 1, wherein the determining statistical information of the residual signal of the current block comprises: determining a statistic of residual pixel values in the residual signal; and
the comparing the statistical information with a first threshold to obtain a comparison result comprises:
comparing the first threshold with the statistic of the residual pixel values to obtain the comparison result.

3. The method according to claim 2, wherein the statistic of the residual pixel values comprises at least one of the following:
an average pixel value of the residual signal;
a quantity of non-zero pixel values comprised in the residual signal;
a ratio of the quantity of non-zero pixel values to a total quantity of pixels comprised in the current block;
a quantity of zero pixel values comprised in the residual signal; and
a ratio of the quantity of zero pixel values to the total quantity of pixels comprised in the current block.

4. The method according to claim 1, wherein the statistical information comprises a block partitioning statistic, and the first threshold comprises a block partitioning threshold, and the determining statistical information of the residual signal of the current block comprises:
collecting statistics on the block partitioning statistic of the current block; and
the comparing the statistical information with a first threshold to obtain a comparison result comprises:
comparing the block partitioning threshold with the block partitioning statistic to obtain the comparison result.

5. The method according to claim 4, wherein the block partitioning statistic is determined based on at least one of a quantity of block partitions, depth of block partitioning, and a quantity of times of block partitioning in the current block.

6. The method according to claim 1, wherein the determining whether to perform loop filtering processing on the reconstructed signal based on the comparison result comprises:
determining not to perform loop filtering processing on the reconstructed signal when the comparison result indicates that the statistical information is less than the first threshold; and
determining to perform loop filtering processing on the reconstructed signal when the comparison result indicates that the statistical information exceeds the first threshold.

7. The method according to claim 1, further comprising:
obtaining a loop filtering flag bit of the current block from the video bitstream; and
determining whether to perform loop filtering processing on the reconstructed signal based on the comparison result and the loop filtering flag bit.

8. The method according to claim 7, wherein the determining whether to perform loop filtering processing on the reconstructed signal based on the comparison result and the loop filtering flag bit comprises at least one of the following:
determining a loop filtering flag value based on the comparison result;
overwriting the loop filtering flag bit based on the loop filtering flag value; and
determining whether to perform loop filtering processing on the reconstructed signal based on the overwritten loop filtering flag bit.

9. An electronic device, comprising:
one or more processors; and
a memory, configured to store one or more computer programs, the one or more computer programs, when executed by the one or more processors, causing the electronic device to implement a video decoding method including:
obtaining a coded video bitstream;
decoding the video bitstream to obtain a residual signal of a current block;
determining a predicted signal of the current block based on the video bitstream;
determining a reconstructed signal of the current block based on the residual signal and the predicted signal;
determining statistical information of the residual signal of the current block;
comparing the statistical information with a first threshold to obtain a comparison result; and
determining whether to perform loop filtering processing on the reconstructed signal based on the comparison result.

10. The electronic device according to claim 9, wherein the determining statistical information of the residual signal of the current block comprises: determining a statistic of residual pixel values in the residual signal; and
the comparing the statistical information with a first threshold to obtain a comparison result comprises:
comparing the first threshold with the statistic of the residual pixel values to obtain the comparison result.

11. The electronic device according to claim 10, wherein the statistic of the residual pixel values comprises at least one of the following:
an average pixel value of the residual signal;
a quantity of non-zero pixel values comprised in the residual signal;
a ratio of the quantity of non-zero pixel values to a total quantity of pixels comprised in the current block;
a quantity of zero pixel values comprised in the residual signal; and
a ratio of the quantity of zero pixel values to the total quantity of pixels comprised in the current block.

12. The electronic device according to claim 9, wherein the statistical information comprises a block partitioning statistic, and the first threshold comprises a block partitioning threshold, and the determining statistical information of the residual signal of the current block comprises:
collecting statistics on the block partitioning statistic of the current block; and
the comparing the statistical information with a first threshold to obtain a comparison result comprises:
comparing the block partitioning threshold with the block partitioning statistic to obtain the comparison result.

13. The electronic device according to claim 12, wherein the block partitioning statistic is determined based on at least one of a quantity of block partitions, depth of block partitioning, and a quantity of times of block partitioning in the current block.

14. The electronic device according to claim 9, wherein the determining whether to perform loop filtering processing on the reconstructed signal based on the comparison result comprises:
determining not to perform loop filtering processing on the reconstructed signal when the comparison result indicates that the statistical information is less than the first threshold; and
determining to perform loop filtering processing on the reconstructed signal when the comparison result indicates that the statistical information exceeds the first threshold.

15. The electronic device according to claim 9, wherein the method further comprises:
obtaining a loop filtering flag bit of the current block from the video bitstream; and
determining whether to perform loop filtering processing on the reconstructed signal based on the comparison result and the loop filtering flag bit.

16. The electronic device according to claim 15, wherein the determining whether to perform loop filtering processing on the reconstructed signal based on the comparison result and the loop filtering flag bit comprises at least one of the following:
determining a loop filtering flag value based on the comparison result;
overwriting the loop filtering flag bit based on the loop filtering flag value; and
determining whether to perform loop filtering processing on the reconstructed signal based on the overwritten loop filtering flag bit.

17. A non-transitory computer-readable medium having a video bitstream stored therein, the video bitstream Being processed by a video decoding method including:
obtaining a coded video bitstream;
decoding the video bitstream to obtain a residual signal of a current block;
determining a predicted signal of the current block based on the video bitstream;
determining a reconstructed signal of the current block based on the residual signal and the predicted signal;
determining statistical information of the residual signal of the current block;
comparing the statistical information with a first threshold to obtain a comparison result; and
determining whether to perform loop filtering processing on the reconstructed signal based on the comparison result.

18. The non-transitory computer-readable medium according to claim 17, wherein the determining statistical information of the residual signal of the current block comprises: determining a statistic of residual pixel values in the residual signal; and
the comparing the statistical information with a first threshold to obtain a comparison result comprises:
comparing the first threshold with the statistic of the residual pixel values to obtain the comparison result.

19. The non-transitory computer-readable medium according to claim 17, wherein the statistical information comprises a block partitioning statistic, and the first threshold comprises a block partitioning threshold, and the determining statistical information of the residual signal of the current block comprises:
collecting statistics on the block partitioning statistic of the current block; and
the comparing the statistical information with a first threshold to obtain a comparison result comprises:
comparing the block partitioning threshold with the block partitioning statistic to obtain the comparison result.

20. The non-transitory computer-readable medium according to claim 17, wherein the method further comprises:
obtaining a loop filtering flag bit of the current block from the video bitstream; and
determining whether to perform loop filtering processing on the reconstructed signal based on the comparison result and the loop filtering flag bit.
